(19) United States
(12) Patent Application Publication
(10) Pub. No.: US 2014/0365878 A1
(43) Pub. Date: Dec. 11, 2014

(54) SHAPE WRITING INK TRACE PREDICTION

(71) Applicant: Microsoft Corporation, Redmond, WA (US)

(72) Inventors: Juan Dai, Sammamish, WA (US); Timothy S. Paek, Sammamish, WA (US); Dmytro Rudchenko, Bellevue, WA (US); Parthasarathy Sundararajan, Bellevue, WA (US); Eric Norman Badger, Redmond, WA (US); Pu Li, Sammamish, WA (US)

(21) Appl. No.: 13/914,481

(22) Filed: Jun. 10, 2013

(51) Int. Cl. G06F 17/24

(52) U.S. Cl. CPC G06F 17/24
USPC 715/256

(57) ABSTRACT

Disclosed herein are representative embodiments of tools and techniques for providing one or more ink-trace predictions for shape writing. According to one exemplary technique, a portion of a shape-writing shape is received by a touchscreen. Based on the portion of the shape-writing shape, an ink trace is displayed. Also, predicted text is determined. The ink trace corresponding to a first portion of the predicted text. Additionally, an ink-trace prediction is provided connecting the ink trace to at least one or more keyboard keys corresponding to one or more characters of a second portion of the predicted text.

### BACKGROUND

Mobile devices with capacitive or resistive touch capabilities are well known. Mobile phones have evolved over the years to the point where they possess a broad range of capabilities. They are not only capable of placing and receiving mobile phone calls, multimedia messaging (MMS), and sending and receiving email, they can also access the Internet, are GPS-enabled, possess considerable processing power and large amounts of memory, and are equipped with high-resolution displays capable of detecting touch input. As such, some of today's mobile phones are general purpose computing and telecommunication devices capable of running a multitude of applications. For example, some modern mobile phones can run word processing, web browser, media player and gaming applications.

As mobile phones have evolved to provide more capabilities, various user interfaces have been developed for users to enter information. In the past, some traditional input technologies have been provided for inputting text, however, these traditional text input technologies are limited.

### SUMMARY

Among other innovations described herein, this disclosure presents various embodiments of tools and techniques for providing one or more ink-trace predictions for shape writing. According to one exemplary technique, a portion of a shape-writing shape is received by a touchscreen. Based on the portion of the shape-writing shape, an ink trace is displayed. Also, predicted text is determined. The ink trace corresponds to a first portion of the predicted text. Additionally, an ink-trace prediction is provided connecting the ink trace to at least one or more keyboard keys corresponding to one or more characters of a second portion of the predicted text.

According to an exemplary tool, a portion of a shape-writing shape is received by a touchscreen. An ink trace is displayed based on the portion of the shape-writing shape. Also, predicted text is determined based on the portion of the shape-writing shape. The ink trace corresponding to a first portion of the predicted text. Additionally, an ink-trace prediction is provided. The ink-trace prediction comprises a line which extends from the ink trace and at least connects to one or more keyboard keys in an order corresponding to an order of one or more characters of a second portion of the predicted text. Also, a determination is made that the shape-writing shape is completed, and the predicted text is entered into a text edit field.

This summary is provided to introduce a selection of concepts in a simplified form that are further described below. This summary is not intended to identify key features or essential features of the claimed subject matter, nor is it intended to be used to limit the scope of the claimed subject matter. The foregoing and other objects, features, and advantages of the technologies will become more apparent from the following detailed description, which proceeds with reference to the accompanying figures.

### BRIEF DESCRIPTION OF THE DRAWINGS

FIG. 1 is a diagram of an exemplary computing device that can provide an ink-trace prediction for shape writing.

FIG. 2 is a flow diagram of an exemplary method for providing an ink-trace prediction for shape writing.

FIG. 3 is a diagram of an exemplary system that can provide an ink-trace prediction and one or more text candidates.

FIG. 4 is a flow diagram of an exemplary method for displaying an ink-trace prediction for predicted text and entering the predicted text into a text edit field.

FIG. 5 is a diagram of an exemplary system for providing an ink-trace prediction for predicted text and entering the predicted text into a text edit field.

FIG. 6 is a schematic diagram illustrating an exemplary mobile device with which at least some of the disclosed embodiments can be implemented.

FIG. 7 is a schematic diagram illustrating a generalized example of a suitable implementation environment for at least some of the disclosed embodiments.

FIG. 8 is schematic diagram illustrating a generalized example of a suitable computing environment for at least some of the disclosed embodiments.

### DETAILED DESCRIPTION

In some implementations of shape writing, a user can write a word or other text in an application via a shape-writing shape gesture on a touch keyboard such as an on-screen keyboard or the like. As the shape-writing shape is being entered, one or more text candidates for predicted text can be displayed as recognized by a shape-writing recognition engine. For example, a recognized text candidate can be displayed in real time or otherwise based on the received portion of the shape-writing shape while the shape-writing shape is being entered via the touchscreen. In some implementations of shape writing, a trace of at least some of a shape-writing shape being entered can be displayed as an ink trace. The ink trace can correspond to at least a portion of the predicted text recognized for the received portion of the shape-writing shape. In some implementations, based on the predicted text, an ink-trace prediction can be provided overlapping the on-screen keyboard to correspond to a portion of the predicted text, which has not been traced by the ink trace, as a guide to complete the shape-writing shape for the predicted text.

### Exemplary System for Providing an Ink-Trace Prediction

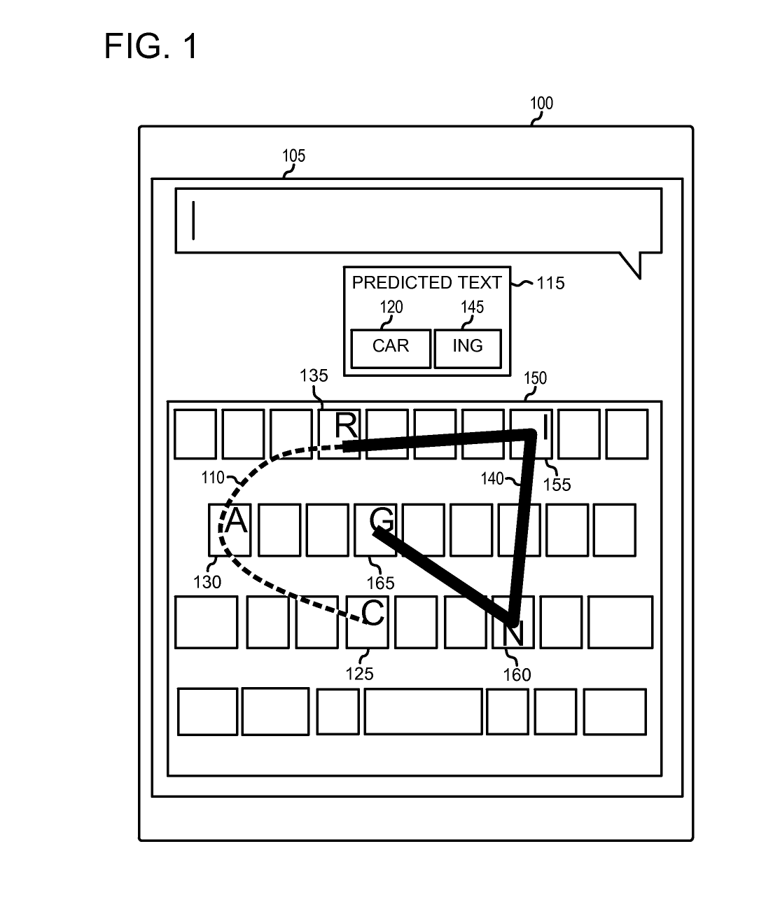

FIG. 1 is a diagram of an exemplary computing device 100 that can render and/or display an ink-trace prediction for shape writing. The computing device 100 receives a portion of a shape-writing shape by a touchscreen 105 and an ink trace 110 is displayed based on the portion of the shape-writing shape. For example, a user can contact the touchscreen 105 to input text using a shape-writing shape gesture and a portion of the shape-writing shape being entered can be received as shape-writing shape information. The portion of the shape-writing shape entered by contact with the touchscreen can be traced by an ink trace at least using a line displayed in the touchscreen 105. The ink trace 110 is illustrated in FIG. 1 as a dashed line.

In FIG. 1, at least one predicted text such as predicted text 115 is determined and the ink trace 110 corresponds to a first portion 120 of the predicted text 115. For example, the received portion of the shape-writing shape can be analyzed by a shape-writing recognition engine and at least based on the analysis of the received portion of the shape-writing shape one or more text candidates can be provided including predicted text such as the predicted text 115. The predicted text 115 can include a first portion 120 of one or more letters and/or characters that correspond to the portion of the shape-writing shape and/or the ink trace of the portion of the shape-writing shape. For example, the word “CARING” can be provided as the predicted text 115, and the letters “CAR” can be the first portion 120 of the predicted text 115. The first portion 120 can correspond to the ink trace 110 such that as the ink trace is displayed at least in part overlapping one or more of the displayed keyboard keys for letters that correspond to one or more letters included in the first portion 120 of the predicted text 115. For example, in FIG. 1, the ink trace 110 overlaps the keyboard key 125 for the letter “C”, the keyboard key 130 for the letter “A”, and the keyboard key 135 for the letter “R”. The keyboard keys 125, 130, and 135 correspond respectively to the letters “C,” “A,” and “R” which are letters included in the first portion 120 of the predicted text 115. For example, the ink trace 110 can be received in response to the user tracing on the touchscreen 105 (e.g., with the user's finger, pen, or stylus) the path (indicated by ink trace 110) from approximately the letter “C” through the letter “A” and ending at the letter “R.”

The ink-trace prediction 140 can be provided such as rendered and/or displayed connecting the ink trace 110 to at least one or more keyboard keys corresponding to one or more characters of a second portion 145 of the predicted text 115. The ink-trace prediction 140 can be displayed at least in part overlapping the on-screen keyboard 150 (e.g., as an overlay or composited on top). The one or more keyboard keys corresponding to the one or more characters of the second portion 145 of the predicted text 115 can be target keys. For example, a keyboard key for a letter that is included as at least one of the letters in the second portion 145 of the predicted text 115 can be a target key. For example, the letters “ING” can be included in the second portion 145 of the predicted text 115, and the ink-trace prediction can be displayed extending from the ink trace 110 connecting at least in part the “I” keyboard key 155, the “N” keyboard key 160, the “G” keyboard key 165. The ink-trace prediction 140 can connect the keyboard keys corresponding to the second portion 145 of the predicted text 115 can be connected by in the order the letters are written in the second portion 145. For example, the keyboard keys can be connected by the ink-trace prediction 140 to provide a prediction of the completed shape-writing shape for the predicted text 115 from the ink trace 110.

### Exemplary Method for Providing an Ink-Trace Prediction

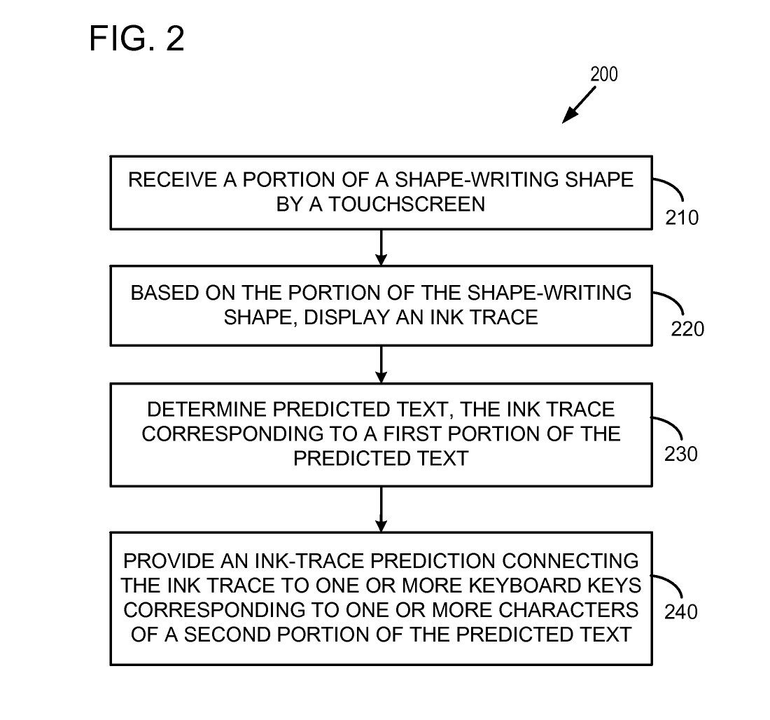

FIG. 2 is a flow diagram of an exemplary method 200 for providing an ink-trace prediction for entering content, such as text content, by drawing or tracing a shape using an on-screen keyboard, which can be called shape writing. In some implementations of shape writing, a user can write and/or enter a word or other text in a text editing field, such as a field of an application for editing text, by entering a shape-writing shape, via a touchscreen, using a shape-writing user interface. In some implementations, a shape gesture such as a shape-writing shape gesture can be performed on a touchscreen and the corresponding shape-writing shape can be received by the touchscreen. In some implementations, a shape-writing shape can be called a gesture shape. In some implementations, the shape-writing shape gesture can include a continuous stroke that maintains contact with the touchscreen from the beginning of the stroke to the end of the stroke. In some implementations, the continuous stroke can continue in one or more directions. In some implementations, the continuous stroke can pause in moving across the touchscreen while maintaining contact with the touchscreen. In some implementations, the shape-writing shape gesture traces one or more on-screen keyboard keys corresponding to the one or more characters in a word or other text. For example, the shape-writing shape (e.g., a gesture shape or the like) corresponding to the shape-writing shape gesture (e.g., a shape gesture or the like) can trace one or more on-screen keyboard keys in an order based on the order that the corresponding one or more characters in the word or other text are arranged. In some implementations, receiving a shape-writing shape can include receiving shape-writing information by a touchscreen that is caused to be contacted by a user.

In FIG. 2, by a touchscreen, a portion of a shape-writing shape is received by a touchscreen at 210. For example, an on-screen keyboard can be displayed by the touchscreen and a user can contact the touchscreen to generate a first portion of a shape-writing shape corresponding to one or more keys of the on-screen keyboard. The portion of the shape-writing shape can be received while the shape-writing shape is being entered. In some implementations, after the first portion is received more of the shape-writing shape can be received. For example, as more of the shape-writing shape gesture is performed, the portion of the shape-writing shape that is received becomes larger.

In some implementations, the portion of the shape-writing shape received corresponds to one or more keys of the on-screen keyboard. For example, the portion of the shape-writing shape can be received by the touchscreen such that the portion of the shape-writing shape connects and/or overlaps with one or more keys of the on-screen keyboard. In some implementations, a shape-writing shape and/or a portion of the shape-writing shape can be received by the touchscreen at least in part by dragging contact with the touchscreen relative to (e.g., on, overlapping, near to, through, across, or the like) the locations of one or more keys displayed for the on-screen keyboard. In some implementations, the portion of the shape-writing shape can be received according to a shape-writing user interface for entering text into one or more applications and/or software.

At 220, an ink trace is displayed based on the portion of the shape-writing shape received. For example, an ink trace can include a displayed trace of at least some of the portion of the shape-writing shape received. In some implementations, an ink trace of the received portion of the shape-writing shape can be rendered and/or displayed in the touch screen. In some implementations, the ink trace can be rendered and/or displayed as growing and/or extending to trace the most recently received portion of the shape-writing shape as the shape-writing shape is being entered. In some implementations, the ink trace can display up to the most updated part of the shape-writing shape received. For example, as a shape-writing shape gesture is being performed contact is made with the touchscreen to enter the information for the shape-writing shape. The ink trace can trace the received portion of the shape-writing shape based on the received information for the shape writing shape.

At 230, at least one predicted text is determined and the ink trace can correspond to a first portion of the predicted text. In some implementations, based at least in part on the received portion of the shape-writing shape, text can be predicted at least using a shape-writing recognition engine. A shape-writing recognition engine can recognize a shape-writing shape and/or a portion of a shape writing shape as corresponding to text such as a word or other text. The text can be included in and/or selected from one or more text suggestion dictionaries used by the shape-writing recognition engine. In some implementations, text can include one or more letters, numbers, characters, words, or combinations thereof.

In some implementations, a first portion of the at least one predicted text can be determined to be entered based at least in part on the received portion of the shape-writing shape. For example, a shape-writing recognition engine can recognize the received portion of the shape-writing shape as corresponding to a first portion of the at least one predicted text. In some implementations, the first portion of the at least one predicted text can be one or more characters, such as letters or other characters, included in the predicted text that have been traced and/or overlapped by the received portion of the shape-writing shape and/or ink trace. In some implementations, a shape-writing recognition engine can recognize the received portion of the shape-writing shape as corresponding to and/or otherwise associated with the first portion of the at least one predicted text. For example, the shape-writing recognition engine can determine which of one or more keys, of the on-screen keyboard, corresponding to letters and/or characters of the predicted text are overlapped by and/or otherwise associated with the received portion of the shape-writing shape and/or the ink trace.

In some implementations of determining the at least one predicted text, the shape-writing recognition engine can recognize the received portion of the shape-writing shape as corresponding with text included in at least one text suggestion dictionary. The recognized text can be provided as predicted text. In some implementations, the at least one predicted text can be provided as included in a text candidate. For example, the predicted text can be included in a text candidate rendered for display and/or displayed in a display such as a touchscreen or other display. The text candidate can be displayed in the touchscreen to indicate the text that has been recognized and/or determined to correspond to the entered portion of the shape-writing shape. In some implementations, more than one text candidate can be provided. For example, a first text candidate can be provided that includes a first predicted text and a second text candidate can be provided that includes a second predicted text. In some implementations, the first predicted text is different than the second predicted text.

In some implementations, the determination of the at least one predicted text can be further based at least in part on a language context. For example, in addition to the received shape-writing shape information, the predicted text can be determined based at least in part on a language model. The language model can be used to predict which text included in one or more text suggestion dictionaries is to be provided as predicted text. For example, a user can be writing text in a text edit field at least by entering the shape-writing shape to enter the text into a text edit field and/or application. The text edit field can include text previously entered. The determination of the predicted text can be based at least in part on the previously entered text in the text edit field. For example, a language model can consider one or more of grammar rules, one or more previously entered words in the text edit field, a user input history, lexicon, or the like to select at least one text for providing as predicted text.

In some implementations, one or more words or other texts can be determined as predicted texts. For example, more than one text is recognized as corresponding to the shape-writing shape and/or selected using a language model and the recognized texts are provided as predicted texts. In some implementations, respective of the predicted texts are displayed as included in text candidates in the touchscreen display as the shape-writing shape is being entered and/or received. During the determination of a predicted text, the predicted text can be assigned a weight as a measure of the prediction confidence. For example, a prediction confidence can be measured based on the analysis of the received portion of the shape-writing shape by the shape-writing recognition engine and/or the language model analysis. In some implementations, a prediction of text that is more confident can have a higher weight than a prediction of text that is less confident. In another implementation, a prediction of text that is more confident can have a lower weight than a prediction of text that is less confident. If more than one text is predicted, respective of the predicted texts can be ranked based on the respective weights of the respective predicted texts. For example, a first predicted text can be ranked higher than a second predicted text because the first predicted text has a confidence measure weight that indicates a more confident prediction than the confidence measure weight for the second predicted text.

In some implementations, the highest ranked predicted text can be automatically selected for use as the at least one predicted text for use in providing an ink-trace prediction. For example, the predicted text with the highest confidence measure weight can be automatically used for providing an ink-trace prediction. In some implementations, a text candidate can be rendered for display and/or displayed in the touchscreen based on the weight of the predicted text included in the text candidate. In some implementations, the text candidate can be ranked according to the ranking of predicted text included in the rendered and/or displayed text candidate. For example, text candidates can be listed in the touchscreen in order of the ranks of their respective included predicted texts or displayed in some other order. In some implementations, the text candidate can be located in the touchscreen to indicate that it is the highest ranking text candidate. In some implementations, the text candidate can be accented to indicate it is the highest ranking text candidate. For example, the highest ranking text candidate can include the highest ranking predicted text and can be displayed as accented in the touchscreen. In some implementations of accenting a text candidate, the text candidate cab be highlighted, bolded, a different size, a different font, include a different color than other text candidates, or other like accenting.

In some implementations, respective of the predicted texts can be included in a rendered and/or displayed text candidate. In some implementations, one or more text candidates can be displayed in an arrangement based on a ranking of the predicted text included in the displayed text candidate. For example, respective text candidates displayed can include respective words determined as predicted text and the respective text candidates can be located in the touchscreen display based on the respective rankings of the respective words. In some implementations, the text candidates can be arranged in the display as a list that lists the text candidate with the highest ranked predicted text first and then lists the remaining text candidates in order of descending rank.

At 240, an ink-trace prediction is provided connecting the ink trace and one or more keyboard keys corresponding to one or more characters of a second portion of the at least one predicted text. For example, the ink-trace prediction can be rendered for display and/or displayed in the touchscreen to connect the ink trace with one or more keyboard keys for one or more characters in a second portion of the predicted text. In some implementations, the ink-trace prediction can include a displayed path and/or line shown as a prediction of the portion of the shape-writing shape that completes the shape-writing shape from the received portion of the shape-writing shape for the at least one predicted text. For example, the ink-trace prediction can be a displayed path that leads from an end of the ink trace to connect one or more target keys based on the at least one predicted text. In some implementations, the ink-trace prediction can be displayed connecting to and/or extending from the ink trace and the ink-trace prediction can be further displayed connecting at least in part one or more target keys of the on-screen keyboard that are determined based on the at least one predicted text.

In some implementations, a target key can be a keyboard key (e.g., a key of an on-screen keyboard or other keyboard) that is for and/or corresponds to a character (e.g., a character of text) included in the at least one predicted text. In some implementations, a keyboard key corresponding to and/or for a letter and/or character can be tapped and/or typed on to enter the letter into a text edit field of an application. In some implementations, shape-writing on keyboard keys can be used to enter text into a text edit field.

In some implementations, one or more target keyboard keys can be determined based on the second portion of the at least one predicted text. In some implementations, the second portion of the at least one predicted text can be one or more characters included in the predicted text that come after the first portion of the at least one predicted text. For example, the first portion of the at least one predicted text can be one or more characters of a beginning portion of the at least one predicted text and the second portion of the at least one predicted text can be one or more characters of the remaining characters included in the at least one predicted text that follow the first portion. The one or more target keyboard keys can include one or more keyboard keys that are for and/or correspond to at least one character included in the second portion of the at least one predicted text.

In some implementations of an ink-trace prediction, the ink-trace prediction connects the target keyboard keys in an order based on the order of the one or more characters included in the second portion of the at least one predicted text. For example, the ink-trace prediction can be displayed connecting the target keyboard keys corresponding to the characters in the second portion of the at least one predicted text in the order the characters are included in the second portion of the at least one predicted text. In some implementations, one or more target keys can be accented based on the at least one predicted text. For example, using the predicted text, the next target key along the ink-trace prediction after the displayed ink trace can be highlighted or otherwise accented as a target for a user to trace the target key. In some implementations, one or more target keys are not accented based on the at least one predicted text.

In some implementations, an ink-trace prediction can include a line. For example, the ink-trace prediction can include a line that shows a path from the ink trace that at least connects one or more target keys of the on-screen keyboard. In some implementations, the ink-trace prediction can include one or more of a curved line, a dashed line, a dotted line, a solid line, a straight line, a colored line, a textured line, or other line. In some implementations, a line included in the ink-trace prediction can be rendered and/or displayed using curve fitting and/or curve smoothing techniques. In some implementations, an ink-trace prediction can include a line that follows one or more directions with one or more curves and/or one or more angles.

The ink-trace prediction can be displayed and/or rendered as extending in one or more directions. For example, the ink-trace prediction can include one or more corners. For example, a displayed portion of a line of an ink-trace prediction displayed as leading toward a first target key can intersect, at a corner, with a different portion of the line of the ink-trace prediction that leads away from the first target key in a different direction towards a different target key.

The ink-trace prediction can be displayed using one or more of various visual characteristics such as colors, textures, line types, widths, shapes, and the like. In some implementations, the ink-trace prediction is displayed with one or more different visual characteristics than the displayed ink trace. For example, in some implementations, a provided ink-trace can include a solid line and the provided ink-trace prediction can include a dashed line. In another implementation, the displayed ink trace can include a dashed line and the displayed ink-trace prediction can include a solid line.

In some implementations, the ink-trace prediction can be displayed and/or rendered dynamically. For example, as more of the shape-writing shape is entered and/or received, the ink-trace prediction can grow and/or be extended. In some implementations, the ink-trace prediction can be rendered and/or displayed to show a path that overlaps at least in part one target key. For example, the ink-trace prediction can be displayed as a path that overlaps a series of keys included in the on-screen keyboard. In some implementations, the ink-trace prediction can be rendered and/or displayed as overlapping one or more keys of the on-screen keyboard that are for characters which are not included in the second portion of the predicted text. For example, the path of the ink-trace prediction displayed between two target keys can overlap one or more keys that are not target keys. In some implementations, the ink-trace prediction can be drawn based on a stored shape-writing shape for the predicted text. For example, the portion of the saved shape-writing shape that corresponds to the second portion of the predicted text can be traced at least in part to display the ink-trace prediction.

In some implementations, the ink-trace prediction can be displayed with a color that is coordinated with the color of the predicted text as displayed in the touch screen. For example, the predicted text can be displayed as including a color as part of a text candidate displayed in the touchscreen and the ink-trace prediction for the at least one predicted text can be displayed including the color. In some implementations, the ink-trace prediction is not displayed with a color that is coordinated with the color of the predicted text as displayed in the touch screen. In some implementations, if there is a text candidate (e.g., a sole text candidate) displayed in the touch screen that includes a predicted text, the displayed ink-trace prediction for the predicted text can be displayed visually to indicate that the predicted text can be selected for entry into a text edit field if the gesture is completed by breaking contact with the touchscreen. In some implementations, if there is a text candidate (e.g., a sole text candidate) displayed in the touch screen that includes a predicted text, the displayed ink-trace prediction for the predicted text is not displayed visually to indicate that the predicted text can be selected for entry into a text edit field if the gesture is completed by breaking contact with the touchscreen.

In some implementations, the ink-trace prediction for the at least one predicted text can be provided based at least in part on a measure of the prediction confidence for the at least one predicted text satisfying a confidence threshold. For example, the predicted text can be associated with a weight as the measure of the prediction confidence for the predicted text. In some implementations, the weight can be compared to a confidence threshold. The confidence threshold can be set such that if a weight for the predicted text satisfies the confidence threshold, then an ink-trace prediction can be provided based on the predicted text. In some implementations, the confidence threshold can be set such that if a weight for the predicted text does not satisfy the confidence threshold, then an ink-trace prediction is not provided based on the predicted text.

In an exemplary implementation, a confidence threshold can be set at a value indicating a 70% confidence of prediction or set at some other value indicating a threshold confidence of prediction, and the confidence threshold can be compared to the weight of the predicted text. If the weight of the predicted text indicates that the confidence of the prediction for the predicted text is greater than the value of the confidence threshold, then the weight of the predicted text can satisfy the confidence threshold and an ink-trace prediction can be provided based on the predicted text. Also, according to the exemplary implementation, if the comparison indicates that the confidence of the prediction for the predicted text is less than the value of the confidence threshold, then the weight of the predicted text does not satisfy the confidence threshold and an ink-trace prediction is not provided for the second portion of the predicted text. In some implementations, if the weight of the predicted text does not satisfy the confidence threshold and/or no predicted text is determined to be associated with the received portion of the shape-writing shape, the ink trace displayed can change color and/or otherwise be changed visually. For example, the ink trace can be displayed in a first color but then it can be changed to a different color.

In some implementations, an ink-trace prediction can be displayed after a time latency. For example, a predetermined time can be allowed to pass during the entry of the shape-writing shape before an ink-trace prediction is displayed. In some implementations, the ink-trace prediction can be displayed after a predetermined number of letters and/or characters have been entered via the received portion of the shape-writing shape. In some implementations, the ink-trace prediction can be displayed at least in part responsive to the detection and/or determination of a pausing of the contact with the on-screen keyboard when the shape-writing shape is being entered via a shape-writing shape gesture.

### Exemplary System for Providing an Ink-Trace Prediction and Text Candidates

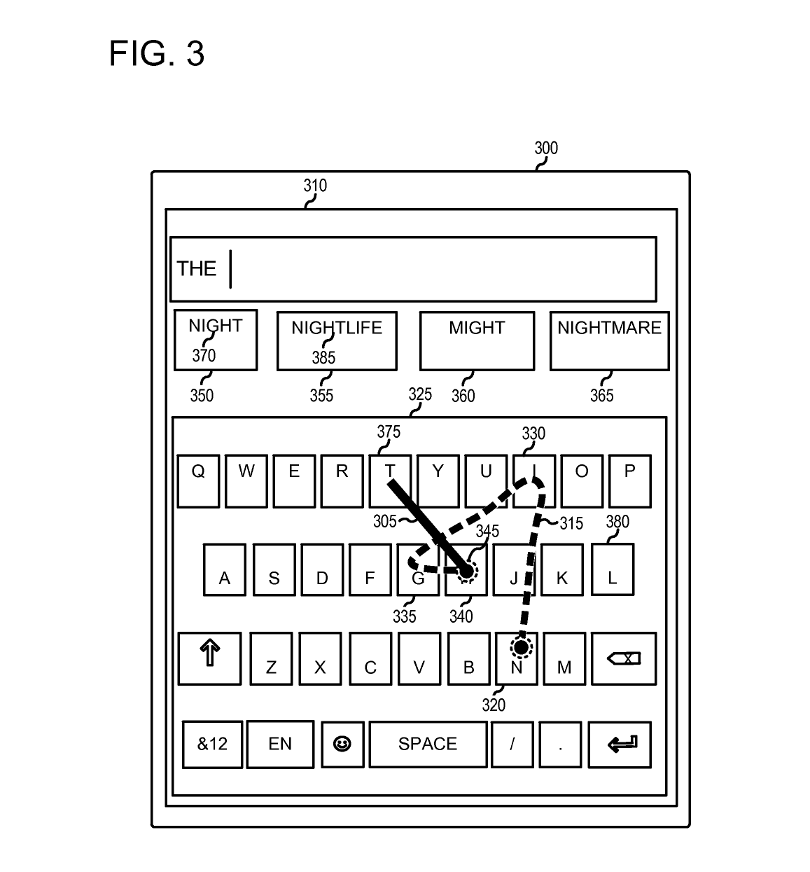

FIG. 3 is a diagram of an exemplary computing device 300 that can provide an ink-trace prediction 305 and one or more text candidates. In FIG. 3, a user contacts the touchscreen 310 of the computing device 300 to enter a portion of a shape-writing shape that is traced by an ink trace 315. The ink trace 315 is illustrated in FIG. 3 as a dashed line for illustration purposes and, in some implementations, the ink trace 315 can be displayed with other visual characteristics. The ink trace 315 traces the received portion of the shape-writing shape that begins as overlapping the key 320 which corresponds to the letter “N” and continues across the on-screen keyboard 325 to overlap the key 330 which corresponds to the letter “I”. The received shape-writing shape continues from the key 330 across the on-screen keyboard 325 to overlap the key 335 which corresponds to the letter “G” and continues on to overlap the key 340 which corresponds to the letter “H”. The ink trace 315 ends overlapping the key 340 as illustrated at 345. In some implementations, as more of the shape-writing shape is received the ink trace can continue to trace the received portion of the shape-writing shape and the end of the ink trace can move relative to the end of the received portion of the shape-writing shape.

Based on the received portion of the shape-writing shape, one or more predicted text is provided as included in one or more displayed text candidates such as the listed text candidates 350, 355, 360, and 365. The text candidate 350 includes the predicted text 370 which is the word “NIGHT”. The predicted text 370 is the highest ranking predicted text and listed as included in the first listed text candidate 350.

In FIG. 3, a first portion of the predicted text 370 corresponds to the displayed ink trace 315 which is displayed in the touchscreen 310. The first portion of the predicted text 370 includes the letters “NIGH” as they are ordered in the word “NIGHT”. The first portion of the predicted text 370 correspond to the shape-writing shape and/or the ink trace 315 based at least in part on a shape-writing recognition engine recognizing the received portion of the shape-writing shape and/or ink trace as having overlapped and/or is otherwise associated with one or more of the keys of the on-screen keyboard 325 corresponding to the letters “N,” “I,” “G,” or “H.”

In FIG. 3, the ink-trace prediction 305 is displayed in the touchscreen 310, connecting the ink trace 315 to the key 375, which corresponds to the letter “T”, in the on-screen keyboard 325. The key 375 corresponds to the letter “T” which is a character included in a second portion of the predicted text 370. The letter “T”, as the second portion, follows the first portion of the predicted text which was recognized by the shape-writing recognition engine as associated with the received portion of the shape-writing shape and/or its ink trace. The second portion of the predicted text 370 completes the word “NIGHT” when combined with the first portion of the predicted text 370. The ink-trace prediction 305 can be displayed as a prediction of a completing portion of an ink trace of the completed shape-writing shape for the predicted text 370 from the ink trace 315.

In some implementations, as more of the shape-writing shape is entered and/or received the ink-trace prediction can be changed base on the additional received information for the shape-writing shape. In some implementations, after receiving a first portion of the shape-writing shape and providing an ink-trace prediction, an additional portion of the shape-writing shape can be received and predicted text can be determined based on the received first and additional portions of the shape-writing shape. For example, a shape-writing recognition engine can analyze the received portions of the shape-writing shape and update the text predictions for the shape-writing shape and/or provide new text predictions based on the received portions of the shape-writing shape. The text predictions can be one or more text predictions that can be included in text candidates for display. In some implementations, the newly predicted texts can be ranked based on the updated information for the shape-writing shape. The predicted text based on the first portion of the shape-writing shape that is used to display the ink-trace prediction can be first predicted text. The predicted text based on the first and additional portions of the shape-writing shape can be second predicted text. The second predicted text can be used to provide an updated ink-trace prediction.

In some implementations, after receiving the first and additional portions of the shape-writing shape, the first predicted text can be given a lower rank than the second predicted text or the first predicted text can no longer be provided as predicted text based on the updated information for the shape-writing shape. The ink-trace prediction can be updated based on the portions of the shape-writing shape that are received. The updated ink-trace prediction can extend from the ink trace of the received portions of the shape-writing shape to connect the ink trace to one or more keyboard keys corresponding to one or more characters the second predicted text. In some implementations, after a first portion of the second predicted text is recognized by shape-writing recognition engine as corresponding to the received portions of the shape-writing shape, the updated ink-trace prediction can connect keyboard keys corresponding to one or more of the remaining characters of the second predicted text that comprise a second portion of the second predicted text. The updated ink-trace prediction can be a displayed prediction of the remaining portion of the ink trace of the completed shape-writing shape for the second predicted text.

In an exemplary implementation with reference to FIG. 3, if the user continues to enter the shape-writing shape such that the ink trace of the received portions of the shape-writing shape continued from the key 340 to the key 375 and then to the key 380 which corresponds to the letter “L,” then the shape-writing recognition engine of the computing device 300 can update the text candidates based on the updated information for the shape-writing shape. At least based in part on the received portions of the shape-writing shape, the shape-writing recognition engine can determine the predicted text 385 is the highest ranking predicted text and can provide an ink-trace prediction based on the predicted text 385.

### Exemplary Method for Providing an Ink-Trace Prediction for Predicted Text and Entering the Predicted Text

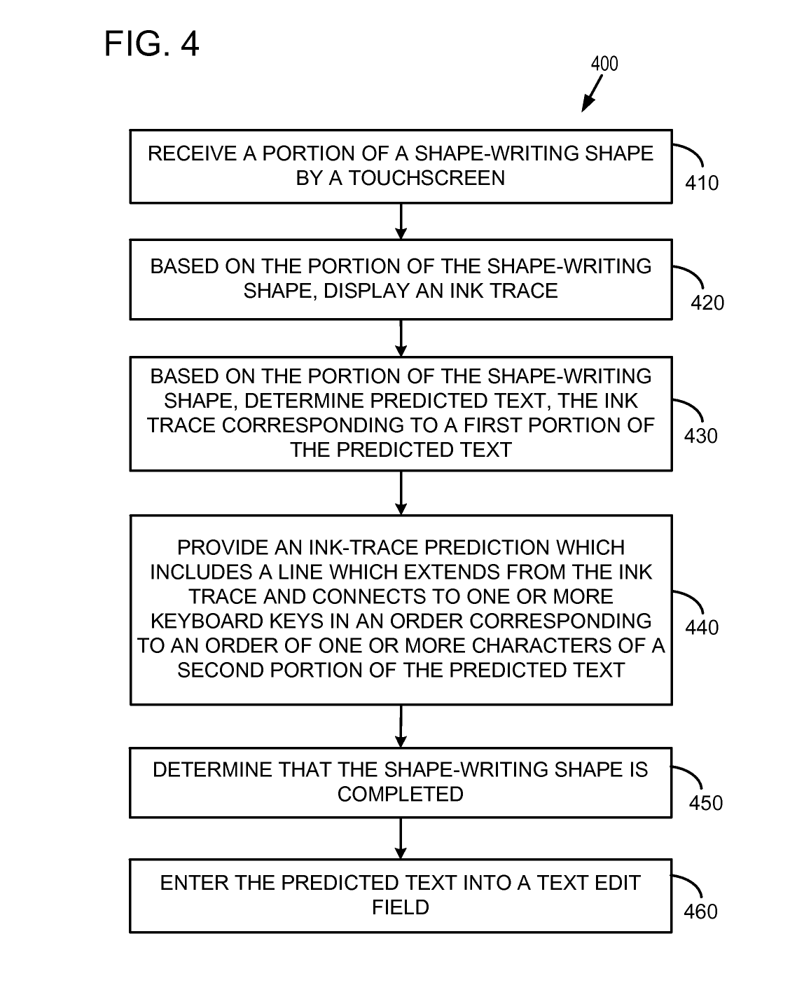

FIG. 4 is a flow diagram of an exemplary method 400 for providing an ink-trace prediction for predicted text and entering the predicted text into a text edit field. In FIG. 4, a portion of a shape-writing shape is received by a touchscreen at 410. For example, while a user enters a shape-writing shape using a touchscreen of a computing device, information for the portion of the shape-writing entered can be received.

At 420, an ink trace is displayed based on the received portion of the shape-writing shape. For example, the ink trace can be displayed tracing at least some of the portion of the entered and/or received portion of the shape-writing shape. In some implementations, as more of the shape-writing shape is entered the ink trace can continue to trace the received updated information for the shape-writing shape. For example, as the shape-writing shape is being entered, the ink trace can use the received information for the shape-writing shape to trace the shape-writing shape while it is being entered. In some implementations, the ink trace can display a trace of the shape-writing shape up to and including a location relative to (e.g., near, overlapping, or the like) where the contact of the shape-writing shape gesture is located in the touchscreen. In some implementations, the ink trace can follow the contact of the shape-writing shape gesture as information for the shape-writing shape is received from the shape-writing shape gesture being performed.

At 430, at least one predicted text is determined based at least in part on the portion of the shape-writing shape. The ink trace can correspond to a first portion of the at least one predicted text. For example, a shape-writing recognition engine can determine one or more words or other predicted text based at least in part on the received portion of the shape-writing shape. The information received for the portion of the shape-writing shape can be used to predict one or more words or other text for recommendation that have a first portion recognized by the shape-writing recognition engine as corresponding to the received portion of the shape-writing shape. The ink trace and/or the received portion of the shape-writing shape can correspond with the first portion of the at least one predicted text by at least overlapping one or more keys of the on-screen keyboard that correspond to one or more letters and/or characters of the first portion of the at least one predicted text.

At 440, an ink-trace prediction is provided. The ink-trace prediction can include a line which extends from the ink trace and connects to one or more keyboard keys. In some implementations, the ink-trace prediction can connect the one or more keyboard keys in an order corresponding to an order of one or more characters of a second portion of the at least one predicted text. For example, the ink-trace prediction can be a line displayed from an end of or other portion of the displayed ink trace that connects one or more keys determined as targets based on the second portion of the at least one predicted text. The target keys can be connected by the ink-trace prediction in the order their corresponding letters and/or characters are written in the second portion of the at least one predicted text. In some implementations, in addition to overlapping one or more target keys, the ink-trace prediction can overlap keys that do not correspond to the second portion of the at least one predicted text. For example, intervening keys that are between target keys can be overlapped by the displayed ink-trace prediction. In some implementations, the ink-trace prediction for the at least one predicted text can be displayed as a prediction of at least a portion of a shape-writing shape for entering the predicted text. In some implementations, the ink-trace prediction can display a prediction of a trace of keys for entering the remaining portion of the at least one predicted text that is after the first portion of the at least one predicted text which has been traced at least in part by the ink trace. In some implementations, as more information is entered for a shape-writing shape the ink-trace prediction can be displayed from an end of the ink trace of the entered portion of the shape-writing shape as the end of the ink trace is relocated within the touchscreen display based on the updated information entered for the shape-writing shape.

At 450, a determination is made that the shape-writing shape is completed. For example, the shape-writing shape can be completed and the completed shape-writing shape can be received. In some implementations, a shape-writing shape can be determined to be completed based on the shape-writing shape gesture being completed. For example, the shape-writing shape gesture can be completed when the contact, which is maintained with the touchscreen during the entry of the shape-writing shape, is broken with the touchscreen.

At 460, the at least one predicted text is entered into a text edit field. For example, based on the determination that the shape-writing shape is completed, the at least one predicted text for which the ink-trace prediction was displayed is entered into the text edit field of an application. In some implementations, the completion of the shape-writing shape can be a selection of the predicted text for entry into the text edit field. For example, as the shape-writing shape is being entered the predicted text that is used for the ink-trace prediction can be selected by a user by causing the contact with the touchscreen to be broken. For example, to break the contact with the touchscreen, the user can lift up an object from contacting the touch screen such as a finger, stylus, or other object contacting the touchscreen.

In some implementations after the at least one predicted text is entered into a text edit field, the case of the text can be modified by cycling through one or more cases at least by pressing a modifier key (e.g., a shift key or other modifier key) one or more times. For example, the recommended text can be entered and/or received in the text edit field. While the entered predicted text is in a composition mode in the text edit field, one or more presses of a modifier key included in the on-screen keyboard are received. Based at least in part on the received one or more presses of the modifier key, the case of the entered at least one predicted text can be changed. In some implementations, one or more successive taps and/or presses of the modifier key can change the at least one predicted text by displaying the at least one predicted text with a different case for respective of the presses. For example, the at least one predicted text can be displayed as cycling through (e.g., toggling through or the like) various cases as the successive presses of the modifier key are received. In some implementations, based on a press of the modifier key, the entered at least one predicted text can be displayed in a lower case, an upper case, a capitalized case, or other case.

### Exemplary System for Providing an Ink-Trace Prediction for Predicted Text and Entering the Predicted Text

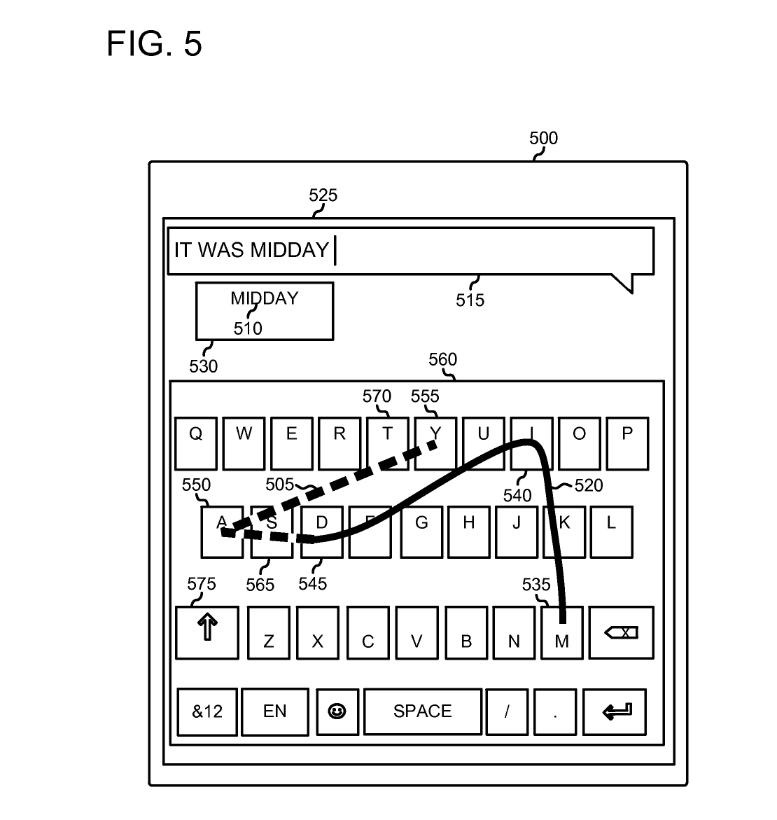

FIG. 5 is a diagram of an exemplary computing device 500 for providing an ink-trace prediction 505 for at least one predicted text 510 and entering the at least one predicted text 510 into a text edit field 515. In FIG. 5, the ink trace 520 is displayed as a solid line by the touchscreen 525 of the computing device 500. The ink trace traces a portion of a shape-writing shape being entered by the touchscreen 525. Based on the received portion of the shape-writing shape, the at least one predicted text 510 is determined by a shape-writing recognition engine of the computing device 500. The at least one predicted text 510 is the word “MIDDAY.” The at least one predicted text 510 is displayed as included in the displayed text candidate 530. The shape-writing shape and/or its ink trace 520 at least connects and/or overlaps the keys 535, 540, and 545 which correspond respectively to the letters “M”, “I”, and “D” which are included as part of a first portion of the predicted text 510. The ink-trace prediction 505 is displayed as a dashed line which connects to an end of the ink trace 520 and follows a path that connects the target key 550 corresponding to the letter “A” followed by the target key 555 corresponding to the letter “Y”. The ink-trace prediction 505 overlaps other intervening keys of the on-screen keyboard 560 such as the key 565 and key 570. In some implementations, an ink-trace prediction can be rendered and/or displayed as beginning in an area near or relative to (e.g., a predetermined distance from or the like) an end of an ink trace. For example, an ink trace can be displayed as ending overlapping a key of the on-screen keyboard and the displayed ink-trace prediction can begin as overlapping the key a distance away from the ink trace and not connecting to the ink trace. In some implementations, the ink-trace prediction 505 can be displayed as a prediction of a completing portion of the shape-writing shape for the at least one predicted text 510 from the ink trace 520.

In some implementations, an ink-trace prediction can be extended as more of the shape-writing shape is entered. For example, the ink-trace prediction can extend from the ink trace to a target key and as the shape-writing shape and/its ink trace overlaps the target key as more of the shape-writing shape is entered, the ink-trace prediction can extend from the ink trace overlapping the target key to connect at least to the next target key as determined by the order of the letters and/or characters of the predicted text. For example, with reference to FIG. 5, the ink-trace prediction 505, can extend from the ink trace 520 to overlap the target key 550 and as the shape-writing shape and/its ink trace 520 overlaps the target key 550 as more of the shape-writing shape is entered, the ink-trace prediction 505 extends from the ink trace 520 to connect at least to the target key 555.

In FIG. 5, the at least one predicted text 510 is entered into the text edit field 515 responsive to the shape-writing shape being completed. The case of the at least one predicted text 510 entered in the text edit field 515 is changed to uppercase responsive to determining that the modifier key 575 has been tapped and/or pressed.

### Exemplary Mobile Device

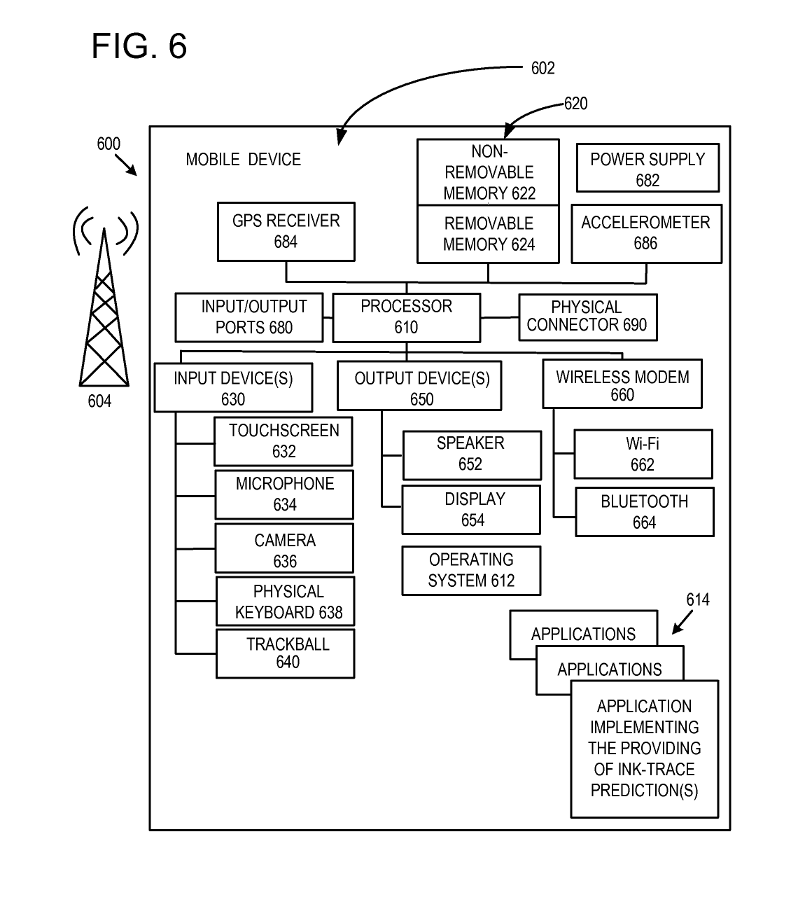

FIG. 6 is a system diagram depicting an exemplary mobile device 600 including a variety of optional hardware and software components, shown generally at 602. Any components 602 in the mobile device can communicate with any other component, although not all connections are shown, for ease of illustration. The mobile device can be any of a variety of computing devices (e.g., cell phone, smartphone, handheld computer, tablet computer, Personal Digital Assistant (PDA), etc.) and can allow wireless two-way communications with one or more mobile communications networks 604, such as a cellular or satellite network.

The illustrated mobile device 600 can include a controller or processor 610 (e.g., signal processor, microprocessor, ASIC, or other control and processing logic circuitry) for performing such tasks as signal coding, data processing, input/output processing, power control, and/or other functions. An operating system 612 can control the allocation and usage of the components 602 and support for one or more application programs 614 such as an application program that can implement one or more of the technologies described herein for providing one or more ink-trace predictions. The application programs can include common mobile computing applications (e.g., email applications, calendars, contact managers, web browsers, messaging applications), or any other computing application.

The illustrated mobile device 600 can include memory 620. Memory 620 can include non-removable memory 622 and/or removable memory 624. The non-removable memory 622 can include RAM, ROM, flash memory, a hard disk, or other well-known memory storage technologies. The removable memory 624 can include flash memory or a Subscriber Identity Module (SIM) card, which is well known in GSM communication systems, or other well-known memory storage technologies, such as “smart cards.” The memory 620 can be used for storing data and/or code for running the operating system 612 and the applications 614. Example data can include web pages, text, images, sound files, video data, or other data sets to be sent to and/or received from one or more network servers or other devices via one or more wired or wireless networks. The memory 620 can be used to store a subscriber identifier, such as an International Mobile Subscriber Identity (IMSI), and an equipment identifier, such as an International Mobile Equipment Identifier (IMEI). Such identifiers can be transmitted to a network server to identify users and equipment.

The mobile device 600 can support one or more input devices 630, such as a touchscreen 632, microphone 634, camera 636, physical keyboard 638 and/or trackball 640 and one or more output devices 650, such as a speaker 652 and a display 654. Other possible output devices (not shown) can include piezoelectric or other haptic output devices. Some devices can serve more than one input/output function. For example, touchscreen 632 and display 654 can be combined in a single input/output device. The input devices 630 can include a Natural User Interface (NUI). An NUI is any interface technology that enables a user to interact with a device in a “natural” manner, free from artificial constraints imposed by input devices such as mice, keyboards, remote controls, and the like. Examples of NUI methods include those relying on speech recognition, touch and stylus recognition, gesture recognition both on screen and adjacent to the screen, air gestures, head and eye tracking, voice and speech, vision, touch, gestures, and machine intelligence. Other examples of a NUI include motion gesture detection using accelerometers/gyroscopes, facial recognition, 3D displays, head, eye, and gaze tracking, immersive augmented reality and virtual reality systems, all of which provide a more natural interface, as well as technologies for sensing brain activity using electric field sensing electrodes (EEG and related methods). Thus, in one specific example, the operating system 612 or applications 614 can comprise speech-recognition software as part of a voice user interface that allows a user to operate the device 600 via voice commands. Further, the device 600 can comprise input devices and software that allows for user interaction via a user's spatial gestures, such as detecting and interpreting gestures to provide input to a gaming application.

A wireless modem 660 can be coupled to an antenna (not shown) and can support two-way communications between the processor 610 and external devices, as is well understood in the art. The modem 660 is shown generically and can include a cellular modem for communicating with the mobile communication network 604 and/or other radio-based modems (e.g., Bluetooth 664 or Wi-Fi 662). The wireless modem 660 is typically configured for communication with one or more cellular networks, such as a GSM network for data and voice communications within a single cellular network, between cellular networks, or between the mobile device and a public switched telephone network (PSTN).

The mobile device can further include at least one input/output port 680, a power supply 682, a satellite navigation system receiver 684, such as a Global Positioning System (GPS) receiver, an accelerometer 686, and/or a physical connector 690, which can be a USB port, IEEE 1394 (FireWire) port, and/or RS-232 port. The illustrated components 602 are not required or all-inclusive, as any components can be deleted and other components can be added.

### Exemplary Implementation Environment

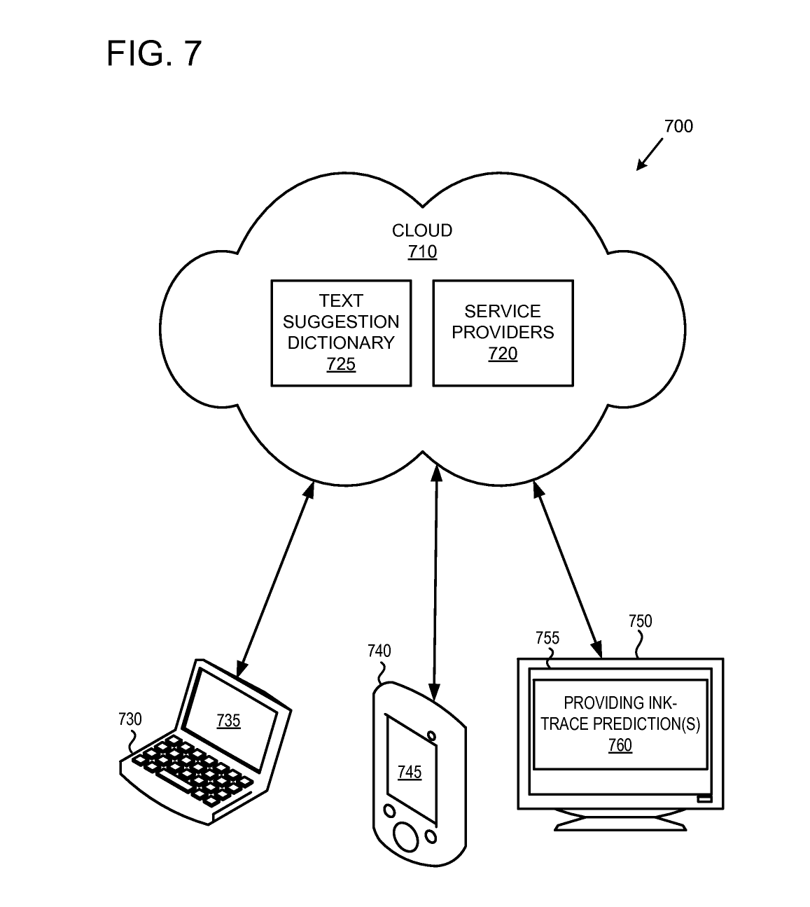

FIG. 7 illustrates a generalized example of a suitable implementation environment 700 in which described embodiments, techniques, and technologies may be implemented.

In example environment 700, various types of services (e.g., computing services) are provided by a cloud 710. For example, the cloud 710 can comprise a collection of computing devices, which may be located centrally or distributed, that provide cloud-based services to various types of users and devices connected via a network such as the Internet. The implementation environment 700 can be used in different ways to accomplish computing tasks. For example, some tasks (e.g., processing user input and presenting a user interface) can be performed on local computing devices (e.g., connected devices 730, 740, 750) while other tasks (e.g., storage of data to be used in subsequent processing) can be performed in the cloud 710.

In example environment 700, the cloud 710 provides services for connected devices 730, 740, 750 with a variety of screen capabilities. Connected device 730 represents a device with a computer screen 735 (e.g., a mid-size screen). For example, connected device 730 could be a personal computer such as desktop computer, laptop, notebook, netbook, or the like. Connected device 740 represents a device with a mobile device screen 745 (e.g., a small size screen). For example, connected device 740 could be a mobile phone, smart phone, personal digital assistant, tablet computer, or the like. Connected device 750 represents a device with a large screen 755. For example, connected device 750 could be a television screen (e.g., a smart television) or another device connected to a television (e.g., a set-top box or gaming console) or the like. One or more of the connected devices 730, 740, 750 can include touchscreen capabilities. Touchscreens can accept input in different ways. For example, capacitive touchscreens detect touch input when an object (e.g., a fingertip or stylus) distorts or interrupts an electrical current running across the surface. As another example, touchscreens can use optical sensors to detect touch input when beams from the optical sensors are interrupted. Physical contact with the surface of the screen is not necessary for input to be detected by some touchscreens. Devices without screen capabilities also can be used in example environment 700. For example, the cloud 710 can provide services for one or more computers (e.g., server computers) without displays.

Services can be provided by the cloud 710 through service providers 720, or through other providers of online services (not depicted). For example, cloud services can be customized to the screen size, display capability, and/or touchscreen capability of a particular connected device (e.g., connected devices 730, 740, 750).

In example environment 700, the cloud 710 provides the technologies and solutions described herein to the various connected devices 730, 740, 750 using, at least in part, the service providers 720. For example, the service providers 720 can provide a centralized solution for various cloud-based services. The service providers 720 can manage service subscriptions for users and/or devices (e.g., for the connected devices 730, 740, 750 and/or their respective users). The cloud 710 can provide one or more text suggestion dictionaries 725 to the various connected devices 730, 740, 750. For example, the cloud 710 can provide one or more text suggestion dictionaries to the connected device 750 for the connected device 750 to implement the providing of one or more ink-trace predictions as illustrated at 760.

### Exemplary Computing Environment

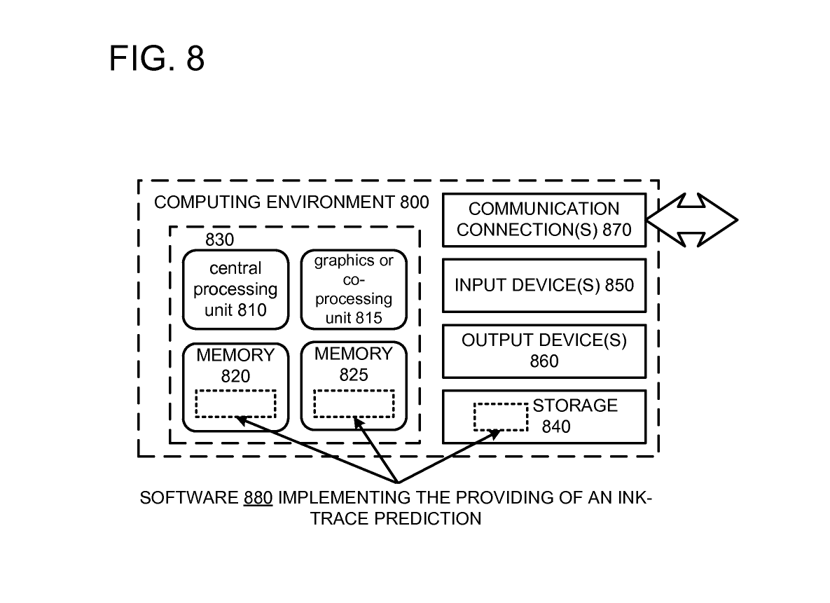

FIG. 8 depicts a generalized example of a suitable computing environment 800 in which the described innovations may be implemented. The computing environment 800 is not intended to suggest any limitation as to scope of use or functionality, as the innovations may be implemented in diverse general-purpose or special-purpose computing systems. For example, the computing environment 800 can be any of a variety of computing devices (e.g., desktop computer, laptop computer, server computer, tablet computer, media player, gaming system, mobile device, etc.).

With reference to FIG. 8, the computing environment 800 includes one or more processing units 810, 815 and memory 820, 825. In FIG. 8, this basic configuration 830 is included within a dashed line. The processing units 810, 815 execute computer-executable instructions. A processing unit can be a general-purpose central processing unit (CPU), processor in an application-specific integrated circuit (ASIC) or any other type of processor. In a multi-processing system, multiple processing units execute computer-executable instructions to increase processing power. For example, FIG. 8 shows a central processing unit 810 as well as a graphics processing unit or co-processing unit 815. The tangible memory 820, 825 may be volatile memory (e.g., registers, cache, RAM), non-volatile memory (e.g., ROM, EEPROM, flash memory, etc.), or some combination of the two, accessible by the processing unit(s). The memory 820, 825 stores software 880 implementing one or more innovations described herein, in the form of computer-executable instructions suitable for execution by the processing unit(s).

A computing system may have additional features. For example, the computing environment 800 includes storage 840, one or more input devices 850, one or more output devices 860, and one or more communication connections 870. An interconnection mechanism (not shown) such as a bus, controller, or network interconnects the components of the computing environment 800. Typically, operating system software (not shown) provides an operating environment for other software executing in the computing environment 800, and coordinates activities of the components of the computing environment 800.

The tangible storage 840 may be removable or non-removable, and includes magnetic disks, flash drives, magnetic tapes or cassettes, CD-ROMs, DVDs, or any other medium which can be accessed within the computing environment 800. The storage 840 stores instructions for the software 880 implementing one or more innovations described herein such as software that implements the providing of one or more ink-trace predictions.

The input device(s) 850 may be an input device such as a keyboard, touchscreen, mouse, pen, or trackball, a voice input device, a scanning device, or another device that provides input to the computing environment 800. For video encoding, the input device(s) 850 may be a camera, video card, TV tuner card, or similar device that accepts video input in analog or digital form, or a CD-ROM or CD-RW that reads video samples into the computing environment 800. The output device(s) 860 may be a display, printer, speaker, CD-writer, or another device that provides output from the computing environment 800.

The communication connection(s) 870 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods.

Any of the disclosed methods can be implemented as computer-executable instructions stored on one or more computer-readable storage media (e.g., one or more optical media discs, volatile memory components (such as DRAM or SRAM), or nonvolatile memory components (such as flash memory or hard drives)) and executed on a computer (e.g., any commercially available computer, including smart phones or other mobile devices that include computing hardware). The term computer-readable storage media does not include communication connections, such as signals and carrier waves. Any of the computer-executable instructions for implementing the disclosed techniques as well as any data created and used during implementation of the disclosed embodiments can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C++, Java, Perl, JavaScript, Adobe Flash, or any other suitable programming language. Likewise, the disclosed technology is not limited to any particular computer or type of hardware. Certain details of suitable computers and hardware are well known and need not be set forth in detail in this disclosure.

It should also be well understood that any functionality described herein can be performed, at least in part, by one or more hardware logic components, instead of software. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

The disclosed methods, apparatus, and systems should not be construed as limiting in any way. Instead, the present disclosure is directed toward all novel and nonobvious features and aspects of the various disclosed embodiments, alone and in various combinations and subcombinations with one another. The disclosed methods, apparatus, and systems are not limited to any specific aspect or feature or combination thereof, nor do the disclosed embodiments require that any one or more specific advantages be present or problems be solved.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope of these claims.

We claim:

1. One or more computer-readable storage media storing computer-executable instructions for causing a computing system to perform a method, the method comprising:
receiving a portion of a shape-writing shape;
based on the portion of the shape-writing shape, displaying an ink trace;
determining at least one predicted text, the ink trace corresponding to a first portion of the at least one predicted text; and
providing an ink-trace prediction connecting the ink trace to at least one or more keyboard keys corresponding to one or more characters of a second portion of the at least one predicted text.

2. The one or more computer-readable storage media of claim 1, wherein the ink-trace prediction comprises a line that extends from the ink trace.

3. The one or more computer-readable storage media of claim 1, further comprising determining the ink-trace prediction based on the one or more characters of the second portion of the at least one predicted text.

4. The one or more computer-readable storage media of claim 1, wherein the one or more keyboard keys are connected by the ink-trace prediction ordered based at least in part on an order of one or more characters of the second portion of the at least one predicted text.

5. The one or more computer-readable storage media of claim 1, wherein the determining the at least one predicted text is based at least in part on the received portion of the shape-writing shape and a prediction context.

6. The one or more computer-readable storage media of claim 1, further comprising:
determining that a confidence measure for the at least one predicted text satisfies a confidence threshold; and
wherein the displaying the ink-trace prediction is responsive to the determining that the confidence measure for the at least one predicted text satisfies the confidence threshold.

7. The one or more computer-readable storage media of claim 1, wherein the ink-trace prediction is displayed with one or more different visual characteristics than the ink trace.

8. The one or more computer-readable storage media of claim 1, wherein the at least one predicted text comprises first predicted text, wherein the portion of the shape-writing shape is a first portion of the shape-writing shape, and wherein the method further comprises:
receiving an additional portion of the shape-writing shape; and
based at least in part on the additional portion of the shape-writing shape, extending the ink-trace prediction.

9. The one or more computer-readable storage media of claim 1, wherein the at least one predicted text comprises first predicted text, wherein the portion of the shape-writing shape is a first portion of the shape-writing shape, and wherein the method further comprises:
receiving an additional portion of the shape-writing shape;
based on the first portion of the shape-writing shape and the additional portion of the shape-writing shape, determining second predicted text; and
displaying an updated ink-trace prediction based on the second predicted text.

10. The one or more computer-readable storage media of claim 1, further comprising:
receiving the at least one predicted text in a text edit field;
receiving one or more presses of a modifier key on an on-screen keyboard; and
based at least in part on the receiving the one or more presses of the modifier key on the on-screen keyboard, changing a case of the at least one predicted text in the text edit field.

11. A method comprising:
receiving, by a touchscreen, a portion of a shape-writing shape;
based on the portion of the shape-writing shape, displaying an ink trace;
determining at least one predicted text, the ink trace corresponding to a first portion of the at least one predicted text; and
providing an ink-trace prediction connecting the ink trace to one or more keyboard keys corresponding to a second portion of the at least one predicted text.

12. The method of claim 11, wherein the ink-trace prediction comprises a line that extends from the ink trace.

13. The method of claim 11, further comprising determining the ink-trace prediction based at least in part on the one or more characters of the second portion of the at least one predicted text.

14. The method of claim 11, wherein the determining the at least one predicted text is based at least on the portion of the shape-writing shape and a prediction context.

15. The method of claim 11, further comprising:
determining a confidence measure for the at least one predicted text;
determining that the confidence measure for the at least one predicted text satisfies a confidence threshold; and
wherein the displaying the ink-trace prediction is responsive to the determining that the confidence measure for the at least one predicted text satisfies the confidence threshold.

16. The method of claim 11, wherein the one or more keyboard keys are connected by the ink-trace prediction ordered based at least in part on an order of the one or more characters of the second portion of the at least one predicted text.

17. The method of claim 11, wherein the at least one predicted text comprises first predicted text, wherein the portion of the shape-writing shape is a first portion of the shape-writing shape, and wherein the method further comprises:
receiving an additional portion of the shape-writing shape;
based on the first portion of the shape-writing shape and the additional portion of the shape-writing shape, determining second predicted text; and
displaying an updated ink-trace prediction based on the second predicted text.

18. The method of claim 11, wherein the at least one predicted text comprises first predicted text, wherein the portion of the shape-writing shape is a first portion of the shape-writing shape, and wherein the method further comprises:
receiving an additional portion of the shape-writing shape; and
based at least in part on the additional portion of the shape-writing shape, extending the ink-trace prediction.

19. The method of claim 11, further comprising:
receiving the at least one predicted text in a text edit field;
receiving one or more presses of a modifier key on an on-screen keyboard; and
based at least in part on the receiving the one or more presses of the modifier key on the on-screen keyboard, changing a case of the at least one predicted text in the text edit field.

20. A computing device comprising at least one processor and memory, the memory storing computer-executable instructions for causing the computing device to perform a method, the method comprising:
receiving, by a touchscreen of the computing device, a portion of a shape-writing shape;
based on the portion of the shape-writing shape, displaying an ink trace;
based on the portion of the shape-writing shape, determining at least one predicted text, the ink trace corresponding to a first portion of the at least one predicted text;
providing an ink-trace prediction, the ink-trace prediction comprising a line which extends from the ink trace and at least connects to one or more keyboard keys in an order corresponding to an order of one or more characters of a second portion of the at least one predicted text;
determining that the shape-writing shape is completed; and
entering the at least one predicted text into a text edit field.
